(19) United States
(12) Patent Application Publication
(10) Pub. No.: US 2013/0035221 A1
(43) Pub. Date: Feb. 7, 2013

(54) APPARATUS AND METHOD FOR SLICING FOOD PRODUCTS

(71) Applicant: Günther Weber, Gross Nemerow (DE)

(72) Inventor: Günther Weber, Gross Nemerow (DE)

(73) Assignee: Weber Maschinenbau GmbH Breidenbach, Breidenbach (DE)

(21) Appl. No.: 13/561,157

(22) Filed: Jul. 30, 2012

(30) Foreign Application Priority Data
Aug. 1, 2011 (DE) 102011109067.7

(51) Int. Cl. B23Q 3/157; B26D 7/26; B23Q 3/155; B26D 1/12

(52) U.S. Cl. 483/1; 483/16; 483/30; 483/10

(57) ABSTRACT

An apparatus for slicing food products includes a cutting blade which moves in a cutting plane to cut off slices from at least one product supplied to the cutting plane and includes a blade changing device which is designed to replace the cutting blade automatically with a replacement cutting blade on the presence of a change criterion.

The present invention relates to an apparatus for slicing food products, in particular a high-performance slicer, having a cutting blade which moves in a cutting plane, in particular in a rotating and/or revolving manner, to cut off slices from at least one product supplied to the cutting plane.

The cutting blade can, for example, be a circular blade orbiting in a planetary motion. Alternatively, a scythe-like blade or a spiral blade can also be provided which rotates about an axis of rotation and has a spiral blade edge. Slices are cut off from a supplied food product such as meat, sausage or cheese at a high cutting rate by the blade edge moving in the cutting plane. The cut-off product slices fall from the cutting blade on the side remote from the supplied product and can be supplied to a further processing.

In particular in the operation of high-performance slicers which have typical cutting speeds between several hundred and some thousand cuts per minute, the respective cutting blades are exposed to high mechanical loads which effect a progressive wear of the cutting blade. The cutting blades have to be replaced at relatively short time intervals due to this blade wear. This is associated with high operating costs since an operator has to shut down the plant, acquire access to the region of the cutting blade and then release the cutting blade from its drivable blade mount using a suitable tool. Subsequently, a new cutting blade has to be fastened to the blade mount. These activities are not only time-consuming, but rather also have the risk of an incorrectly fastened cutting blade. In addition, there is a substantial risk of injury, in particular when handling large and heavy scythe-like blades.

It is therefore an object of the invention to configure the operation of cutting apparatus of the named kind more efficiently and more safely and in particular to simplify the changing of the cutting blade.

The object is satisfied by an apparatus having the features of claim 1. In accordance with the invention, an apparatus for slicing food products includes a blade changing device which is designed to replace the cutting blade automatically with a replacement cutting blade on the presence of a change criterion. The down times of the apparatus can be reduced by such an automatic blade change. Furthermore, operating errors on the releasing and fastening of the cutting blades are avoided. The risk of accident is furthermore also reduced since the replacement process no longer has to be carried out by the operator himself.

The cutting blade can be releasable connectable to a blade mount, with the blade changing device being designed to remove the cutting blade from the blade mount and to connect the replacement cutting blade to the blade mount on the presence of the change criterion. In this manner, a worn cutting blade can be removed from the machine to be supplied, for example, to a sharpening process, while a new or sharpened replacement cutting blade is provided. It must be pointed out in this connection that the cutting blade can also be a relatively narrow blade margin or a blade element at a carrier, with the carrier in such a design forming the blade mount or a part of the blade mount, with the carrier in particular not also being changed.

Further embodiments of the invention are set forth in the dependent claims, in the drawing and in the description.

In accordance with an embodiment of the invention, the apparatus includes a holder which has a plurality of blade mounts and which is movable relative to a product feed of the apparatus by means of the blade changing device such that a respective one of the cutting blades connected to the blade mounts can be selectively moved into a cutting position. This makes possible a particularly fast replacement process, with the machine not even having to be shut down to change the cutting blades in the most favorable case. As soon as one of the cutting blades is worn, a further cutting blade provided at the holder is rather placed in the cutting position, with the product advance optionally having to be interrupted temporarily. The holder can in particular be revolvable in the manner of a tool revolver and can carry a plurality of cutting blades at its periphery. The cutting blades not located in the cutting position can be removed at a suitable time and replaced with new or sharpened cutting blades. Alternatively, the holder, including all the cutting blades provided thereat, could also be replaced as soon as all the cutting blades are worn.

The apparatus can also include a buffer unit, with the blade changing device being designed to supply the removed cutting blade to the buffer unit and/or to remove the replacement cutting blade from the or from a further buffer unit. An operator of the apparatus can then take the removed cutting blade from the buffer unit and place or insert new cutting blades to be provided into the buffer unit, which is substantially simpler and safer to implement than a handling directly at the drivable blade mount.

The change criterion can in particular be based on a degree of wear or state of wear of the cutting blade. Worn cutting blades can thus be replaced automatically before the cutting performance recognizably reduces. It is generally also possible always to carry out an automatic blade change whenever a different blade type is required due to a change in the type of products to be sliced.

The blade changing device can furthermore be designed to remove the replacement cutting blade from a cutting blade magazine taking up a plurality of cutting blades. The operation of the apparatus can be designed particularly efficiently in this manner since an operator does not have to provide a new cutting blade for each blade change. It is rather sufficient if the complete cutting blade magazine is reequipped at relatively long time intervals.

The blade changing device can include at least one electric, pneumatic and/or hydraulic actuating drive to implement the automatic blade change fast and reliably.

In accordance with an embodiment of the invention, the blade changing device includes at least one robot. A robot can carry out all the activities required for a blade exchange and can be used particularly flexibly.

The invention also relates to a method of slicing food products in which a cutting blade is moved in a cutting plane, in particular in a rotating and/or revolving manner, to cut off slices from at least one product supplied to the cutting plane.

In accordance with the invention, the cutting blade is automatically replaced with a replacement cutting blade on the presence of a change criterion.

The operator of the associated plant himself preferably decides when the cutting blade will be replaced. The change criterion in this case comprises a corresponding command of the operator, for example in the form of an actuation of a switch.

The cutting blade is preferably replaced with the replacement cutting blade when the degree of wear of the cutting blade reaches a predefined value and/or when a predefined wear state is present. The degree of wear or the wear state can be detected, for example, continuously by means of a sensor during the cutting operation. It depends on the respective application whether a reaching of the degree of wear or wear state is only displayed to the operator of the plant or whether the apparatus initiates a blade change completely independently as soon as a corresponding degree of wear or wear state is recognized.

The cutting blade can in particular be replaced with the replacement cutting blade in that the cutting blade is removed from the blade mount and a replacement cutting blade is connected to the blade mount.

In accordance with an aspect of the invention, the cutting blade to be replaced is supplied to a buffer unit and/or the replacement cutting blade is removed from the or from a further buffer unit.

The invention will be described in the following by way of example with reference to the drawings.

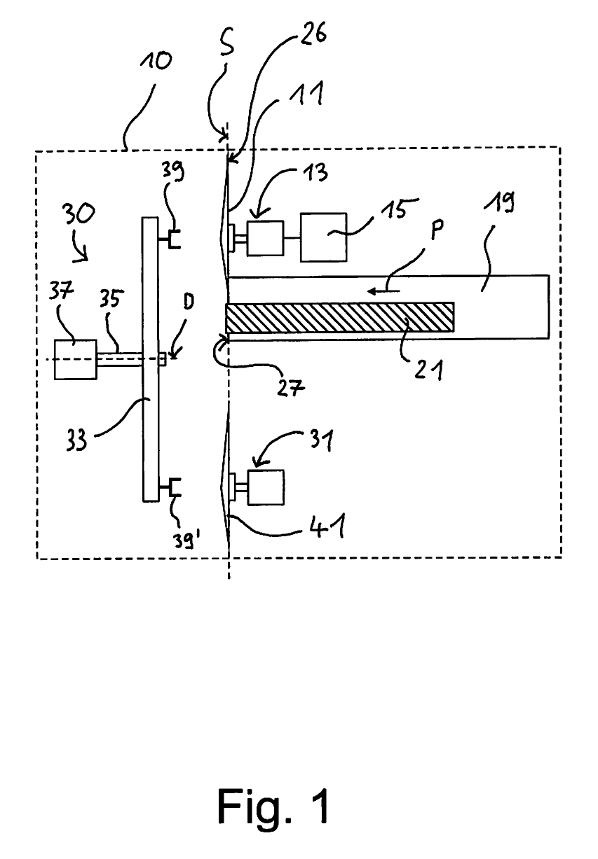

FIG. 1 is a plan view of an apparatus for slicing food products in accordance with an embodiment of the invention; and

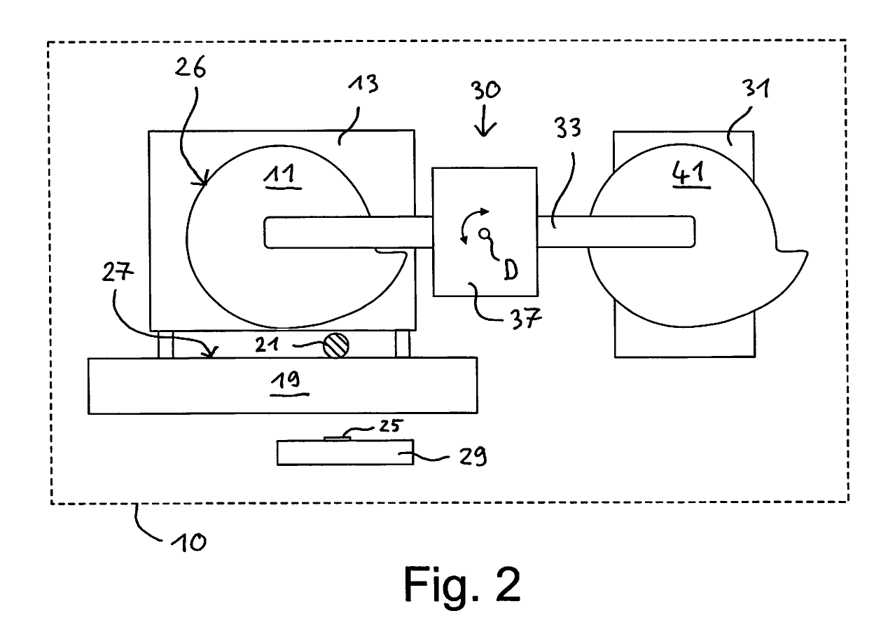

FIG. 2 is a front view of the apparatus in accordance with FIG. 1.

In accordance with FIGS. 1 and 2, a high-performance slicer 10 includes a cutting blade 11 which defines a cutting plane S. The cutting blade 11 is designed here as a disk-like scythe-like blade which is fastened to a blade mount 13. The blade mount 13 with the cutting blade 11 is rotatingly driven in the cutting plane S by means of a drive 15.

Furthermore, the high-performance slicer 10 includes a product feed 19 on which a product loaf or product bar 21 to be sliced is located. It must be pointed out that the product feed 19 could also be designed for the parallel supply of a plurality of product bars 21 arranged next to one another. The product bar 21 is supplied to the rotating cutting blade 11 by means of a controlled drive, not shown, along a product supply direction P facing the cutting plane S at a right angle. During the rotation, the cutting blade 11 slices through the product bar 21 using a blade edge 26 and cuts off product slices 25 (FIG. 2) from it, with it cooperating with a cutting edge 27 forming the end of the product feed 19. The cut-off product slices 25 fall onto a product support 29 (FIG. 2) on the rear side of the blade remote from the product feed 19 and can be conveyed on or further processed and can in particular be supplied to an automatic packaging plant (not shown).

To allow an automatic blade change in the case of an excessive wear of the cutting blade 11, the high-performance slicer 10 includes a blade changing device 30 as well as a replacement cutting blade holder 31. The replacement cutting blade holder 31 is in principle of a similar design to the blade mount 13, but does not have any drive 15 and is preferably arranged such that it is located outside the direct danger zone and is easily accessible for an operator. It carries a new or sharpened, i.e. not worn, replacement cutting blade 41.

The blade changing device 30 includes a two-armed pivot lever 33 which is seated on a shaft 35 rotatable about an axis of rotation D. A controllable electric drive 37 is associated with the shaft 35. Handling tools 39, 39′ are seated at the ends of the pivot lever 33 which are only shown schematically and which are located directly in front of the cutting blade 11 and the replacement cutting blade 41 viewed in the product feed direction P.

A control device, not shown, outputs a signal to the blade changing device 30 as soon as a change criterion is present, i.e. as soon as the operator of the high-performance slicer 10 actuates a corresponding switch or as soon as a sensor detects a critical degree of wear or a specific wear state of the cutting blade 11. As soon as the blade changing device 30 receives the signal, the handling tools 39, 39′ are moved by means of suitable actors toward the cutting blade 11 and the replacement cutting blade 41 and are brought into engagement with them. This engagement takes place such that, on the one hand, the fastening between the blade and the respective holder is loosened and, on the other hand, the cutting blade 11 and the replacement cutting blade 41 are held fast by the handling tools 39, 39′. The handling tools 39, 39′ are now again moved back into the base position shown in FIG. 1 together with the cutting blades 11, 41 and the pivot lever 33 is pivoted about an angle of 180°. After this pivoting process, the handling tools 39, 39′ are again moved toward the blade mount 13 or the replacement cutting blade holder 31 and are fastened thereto. Once the handling tools 39, 39′ have finally again been moved back into the base position, the cutting operation can be restarted using the non-worn replacement cutting blade 41 fastened to the blade mount 13.

The worn cutting blade 11 can be replaced by the operator with a new or sharpened cutting blade. It is not necessary for this purpose that the operator acquires access to the dangerous cutting zone at the driven blade mount 13. The replacement cutting blade holder 31 thus forms a buffer unit for the blade changing device 30 which could generally also be designed for receiving a plurality of cutting blades. The change of the cutting blade 11 takes place fast and while avoiding operating errors so that, on the one hand, long down times for the high-performance slicer 10 can be reduced by the blade changing device 30 and, on the other hand, critical situations due to incorrectly fastened blades are avoided.

### REFERENCE NUMERAL LIST

10 high-performance slicer
11 cutting blade
13 blade mount
15 drive
19 product feed
21 product bar
25 product slice
26 blade edge
27 cutting edge
29 product support
30 blade changing device
31 replacement cutting blade holder
33 two-armed pivot lever
35 shaft
37 drive
39, 39′ handling tool
41 replacement cutting blade
S cutting plane
P product feed direction
D axis of rotation

1-10. (canceled)

11. An apparatus (10) for slicing food products having a cutting blade (11) which moves in a cutting plane (S) to cut off slices (25) from at least one product (21) supplied to the cutting plane (S), wherein
the apparatus includes a blade changing device (30) which is designed to replace the cutting blade (11) automatically with a replacement cutting blade (41) on the presence of a change criterion.

12. An apparatus in accordance with claim 1, wherein the apparatus is a high-performance slicer.

13. An apparatus in accordance with claim 1, wherein the cutting blade (11) moves in a rotating and/or revolving manner in the cutting plane.

14. An apparatus in accordance with claim 1, wherein the cutting blade (11) is releasably connectable to a blade mount (13), with the blade changing device (30) being designed to remove the cutting blade (11) from the blade mount (13) and to connect the replacement cutting blade (41) to the blade mount (13) on the presence of the change criterion.

15. An apparatus in accordance with claim 4, wherein the apparatus includes a holder having a plurality of blade mounts, said holder being movable relative to a product feed of the apparatus by means of the blade changing device such that a respective one of the cutting blades connected to the blade mounts can be selectively moved into a cutting position.

16. An apparatus in accordance with claim 1, wherein the apparatus includes a buffer unit (31), with the blade changing device being designed to supply the removed cutting blade (11) to the buffer unit (31) and/or to remove the replacement cutting blade (41) from the buffer unit (31) or from a further buffer unit (31).

17. An apparatus in accordance with claim 1, wherein the change criterion is based on a degree of wear or on a wear state of the cutting blade (11).

18. An apparatus in accordance with claim 1, wherein the blade changing device is designed to remove the replacement cutting blade from a cutting blade magazine receiving a plurality of cutting blades.

19. An apparatus in accordance with claim 1, wherein the blade changing device includes at least one robot.

20. A method for slicing food products in which a cutting blade (11) is moved in a cutting plane (S) to cut off slices (25) from at least one product (21) supplied to the cutting plane (S), wherein the cutting blade (11) is automatically replaced with a replacement cutting blade (41) on the presence of a change criterion.

21. A method in accordance with claim 10, wherein the method is adapted to be carried out in an apparatus including a blade changing device (30) which is designed to replace the cutting blade (11) automatically with a replacement cutting blade (41) on the presence of a change criterion.

22. A method in accordance with claim 10, wherein the cutting blade moves in a rotating and/or revolving manner in the cutting plane.

23. A method in accordance with claim 10, wherein the cutting blade (11) is replaced with the replacement cutting blade (41) when the degree of wear of the cutting blade (11) reaches a predefined value and/or when a predefined wear state is present.

24. A method in accordance with claim 10, wherein the cutting blade (11) to be replaced is supplied to a buffer unit (31) and/or the replacement cutting blade (41) is removed from the buffer unit (31) or from a further buffer unit (31).
